(19) United States
(12) Patent Application Publication
(10) Pub. No.: US 2026/0188540 A1
(43) Pub. Date: Jul. 2, 2026

(54) METHOD OF MANUFACTURING WIRE HARNESS AND WIRE HARNESS

(71) Applicant: YAZAKI CORPORATION, Tokyo (JP)

(72) Inventors: Akinori Nakashima, Makinohara-shi (JP); Takuya Nakagawa, Makinohara-shi (JP)

(21) Appl. No.: 19/547,541

(22) Filed: Feb. 23, 2026

Related U.S. Application Data
(63) Continuation of application No. PCT/JP2024/030161, filed on Aug. 26, 2024.

(30) Foreign Application Priority Data
Sep. 29, 2023 (JP) 2023-169207

(51) Int. Cl. H01B 13/012; B60R 16/02; H01B 7/00

(52) U.S. Cl. CPC H01B 13/01209; B60R 16/0215; H01B 7/0045

(57) ABSTRACT

A method of manufacturing a wire harness, includes: a process of housing a plurality of electric wires in a groove portion of a jig plate including the groove portion; and a process of forming a trunk wire portion in which the plurality of electric wires is bundled, by attaching a plurality of first bundling members to the plurality of electric wires housed in the groove portion, in which, in the process of forming the trunk wire portion, the first bundling members are attached to the plurality of electric wires in each of a plurality of through holes formed at an interval in the groove portion, and one of the first bundling members goes around the plurality of electric wires at a same position in an extending direction of the electric wires.

### CROSS-REFERENCE TO RELATED APPLICATION(S)

This application is a continuation application of International Application No. PCT/JP2024/030161 filed on Aug. 26, 2024 which claims the benefit of priority from Japanese Patent Application No. 2023-169207 filed on Sep. 29, 2023 and designating the U.S., the entire contents of which are incorporated herein by reference.

### BACKGROUND OF THE INVENTION

### 1. Field of the Invention

The present invention relates to a method of manufacturing a wire harness and the wire harness.

### 2. Description of the Related Art

Wire harnesses have been used. JP 2020-150 774 A discloses a wire harness including a plurality of electric wires, a connector, and constraining tape. The plurality of electric wires constitutes an electric wire bundle. The connector is provided on a terminal of the electric wire bundle, and includes a plurality of connector terminals and a connector housing. The constraining tape is wound around electric wires. The constraining tape is, for example, spirally wound around the electric wire bundle to constrain the plurality of electric wires.

When constraining tape is spirally wound around a trunk wire portion of a wire harness, flexibility of the trunk wire portion easily decreases. Improvement of the flexibility of the trunk wire portion can improve routing property of the wire harness, and improve transportation efficiency.

### SUMMARY OF THE INVENTION

An object of the present invention is to provide a method of manufacturing a wire harness and the wire harness capable of improving flexibility of a trunk wire portion.

In order to achieve the above mentioned object, a method of manufacturing a wire harness according to one aspect of the present invention includes a process of housing a plurality of electric wires in a groove portion of a jig plate including the groove portion; and a process of forming a trunk wire portion in which the plurality of electric wires is bundled, by attaching a plurality of first bundling members to the plurality of electric wires housed in the groove portion, wherein, in the process of forming the trunk wire portion, the first bundling members are attached to the plurality of electric wires in each of a plurality of through holes formed at an interval in the groove portion, and one of the first bundling members goes around the plurality of electric wires at a same position in an extending direction of the electric wires.

In order to achieve the above mentioned object, a wire harness according to another aspect of the present invention includes a trunk wire portion formed by bundling a plurality of electric wires; and a branch wire portion that branches off from the trunk wire portion, wherein the trunk wire portion includes: the plurality of electric wires; and a plurality of first bundling members that bundle the plurality of electric wires, and one of the first bundling members goes around the plurality of electric wires at a same position in an extending direction of the electric wires, bundles the plurality of electric wires, and is arranged separately from another of the first bundling members in the extending direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness according to an embodiment;

FIG. 2 is a cross-sectional view of a first bundling member according to the embodiment;

FIG. 3 is a perspective view of the first bundling member according to the embodiment;

FIG. 4 is a plan view of the first bundling member according to the embodiment;

FIG. 5 is a cross-sectional view of the first bundling member according to the embodiment;

FIG. 6 is a plan view of sub harnesses according to the embodiment;

FIG. 7 is a plan view of a jig plate according to the embodiment;

FIG. 8 is a cross-sectional view of the jig plate according to the embodiment;

FIG. 9 is a cross-sectional view of the jig plate according to the embodiment;

FIG. 10 illustrates a sub harness to be conveyed;

FIG. 11 is a cross-sectional view of the sub harness placed on an inclined surface;

FIG. 12 is a cross-sectional view of the sub harness housed in a groove portion;

FIG. 13 is a plan view of the sub harness housed in the groove portion;

FIG. 14 is a cross-sectional view of the sub harnesses placed on the inclined surface;

FIG. 15 is a cross-sectional view of the sub harnesses housed in the groove portion;

FIG. 16 is a plan view of the sub harnesses housed in the groove portion;

FIG. 17 is a plan view illustrating the first bundling members attached to a trunk wire portion;

FIG. 18 is a cross-sectional view illustrating the first bundling member attached to the trunk wire portion.

FIG. 19 is a cross-sectional view illustrating the wire harness taken out from the groove portion; and

FIG. 20 illustrates the arrangement of the first bundling members in the trunk wire portion.

### DETAILED DESCRIPTION OF THE PREFERRED EMBODIMENTS

A method of manufacturing a wire harness and the wire harness according to an embodiment of the present invention will be described in detail below with reference to the drawings. Note that the invention is not limited by the embodiment. Furthermore, components in the following embodiment include those that can be easily assumed by a skilled person and those that are substantially the same.

### Embodiment

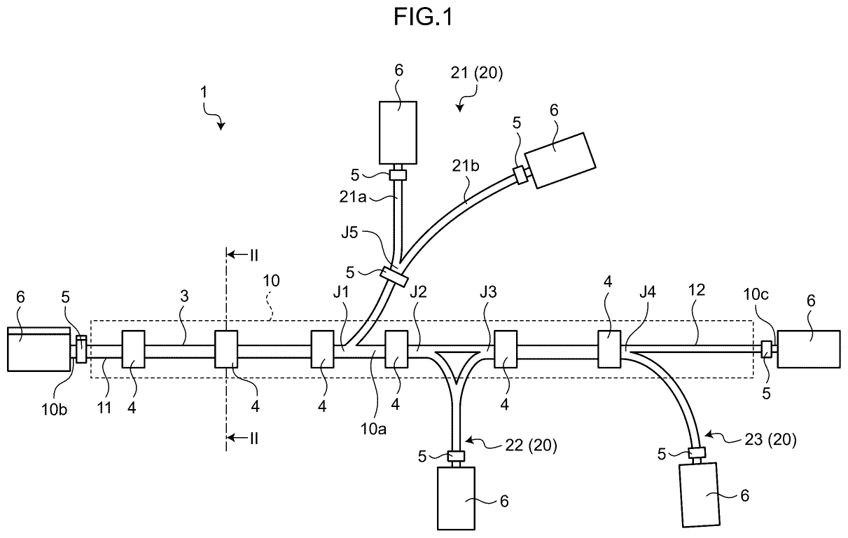

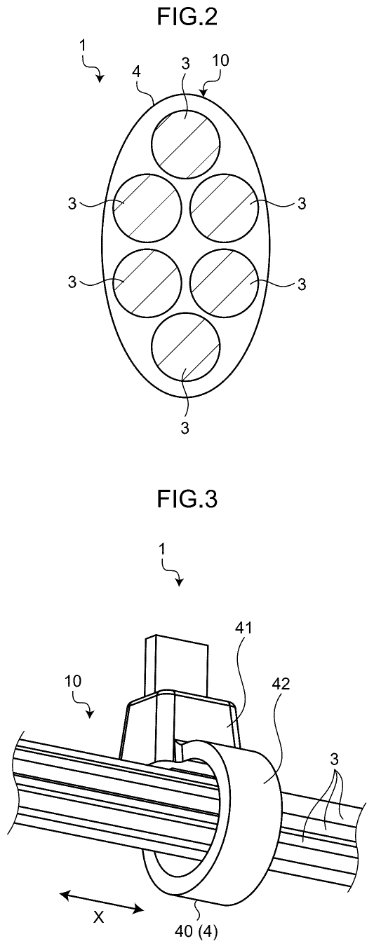

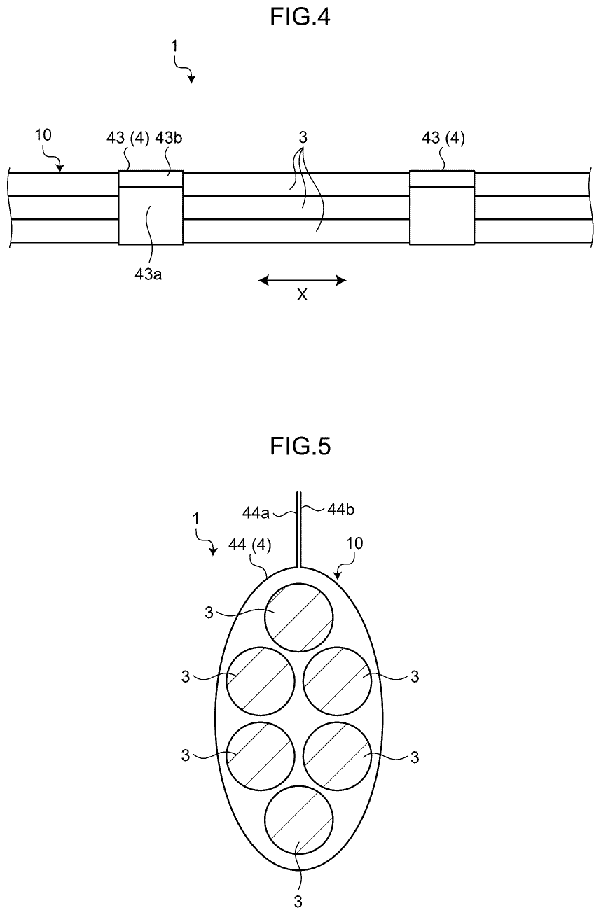

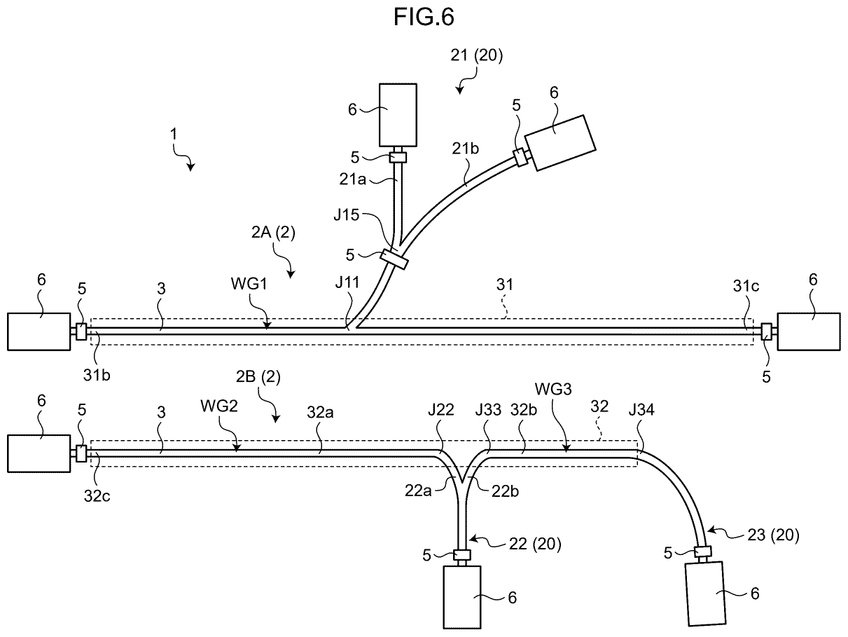

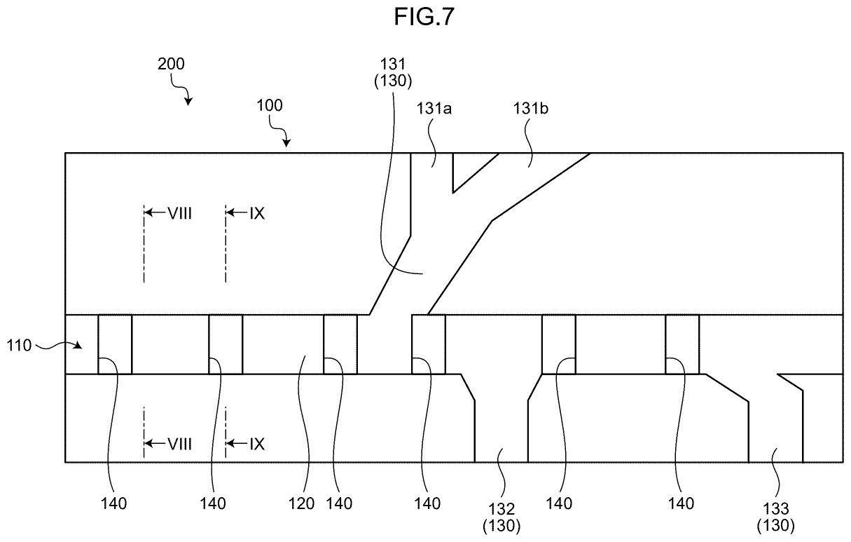

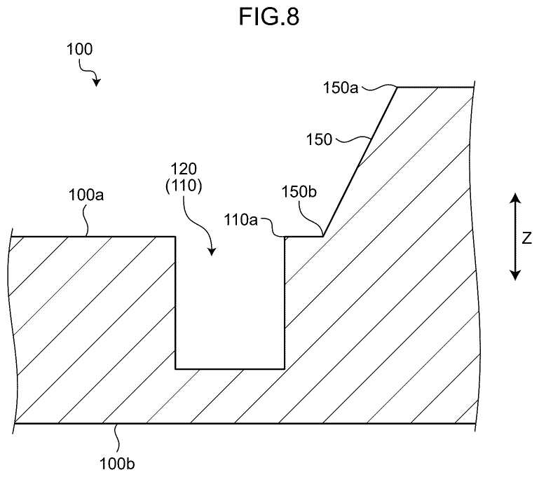

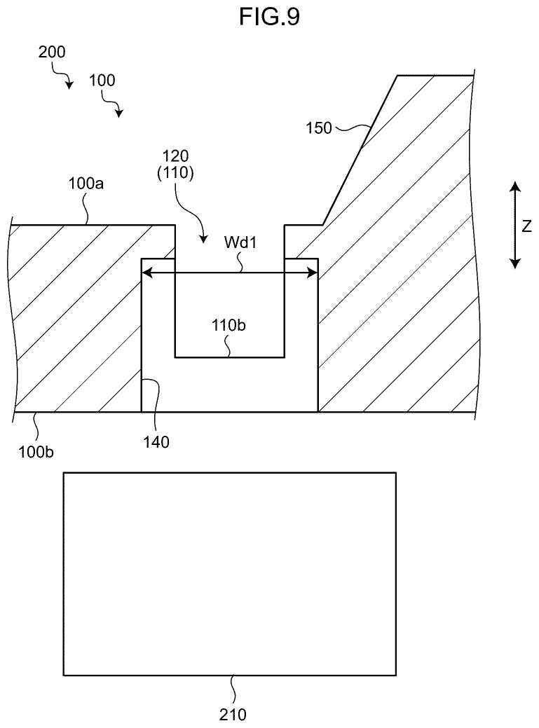

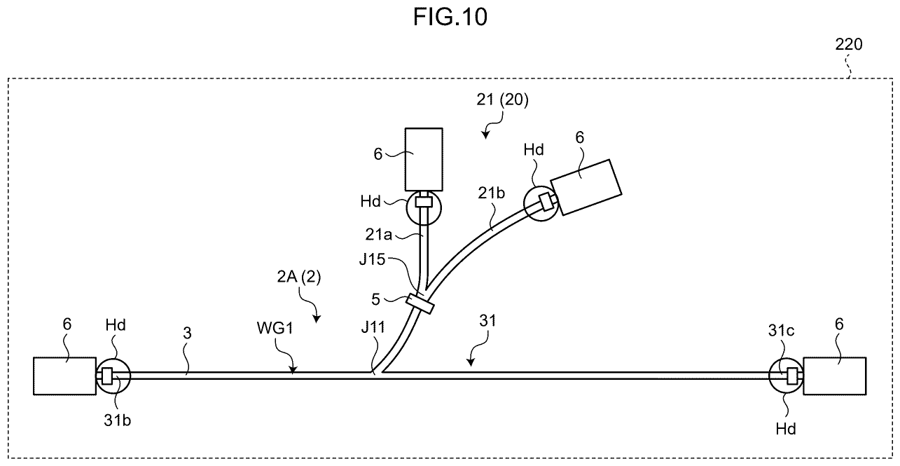

The embodiment will be described with reference to FIGS. 1 to 20. The embodiment relates to a method of manufacturing a wire harness and the wire harness. FIG. 1 is a plan view of the wire harness according to the embodiment. FIG. 2 is a cross-sectional view of a first bundling member according to the embodiment. FIG. 3 is a perspective view of the first bundling member according to the embodiment. FIG. 4 is a plan view of the first bundling member according to the embodiment. FIG. 5 is a cross-sectional view of the first bundling member according to the embodiment. FIG. 6 is a plan view of sub harnesses according to the embodiment. FIG. 7 is a plan view of a jig plate according to the embodiment. FIGS. 8 and 9 are cross-sectional views of the jig plate according to the embodiment. FIG. 10 illustrates a sub harness to be conveyed.

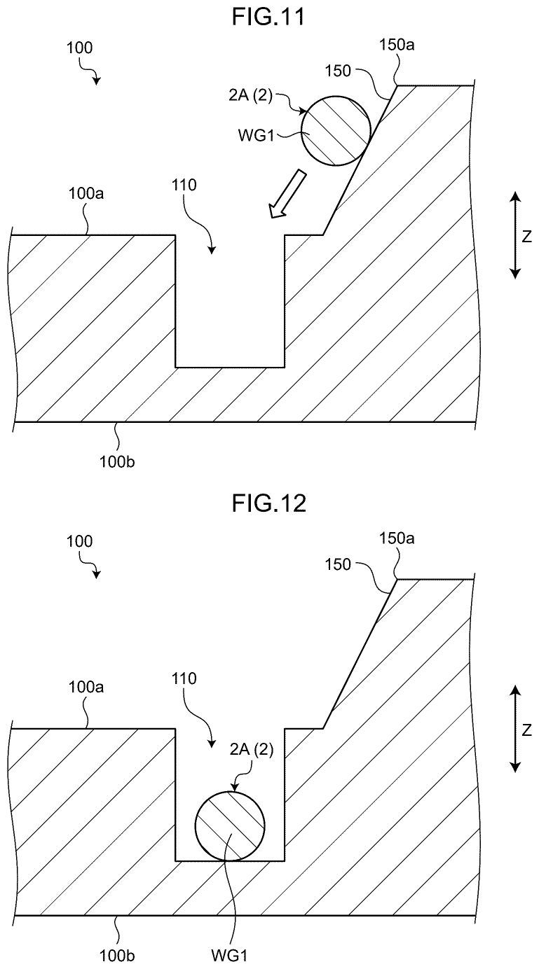

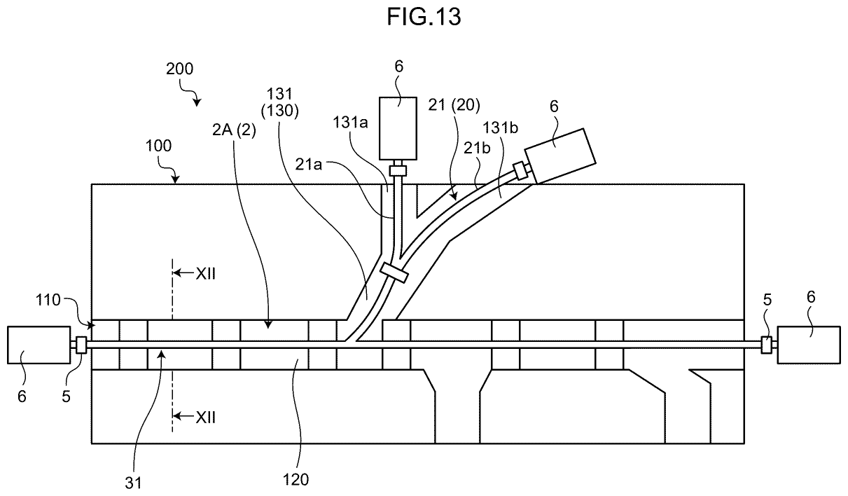

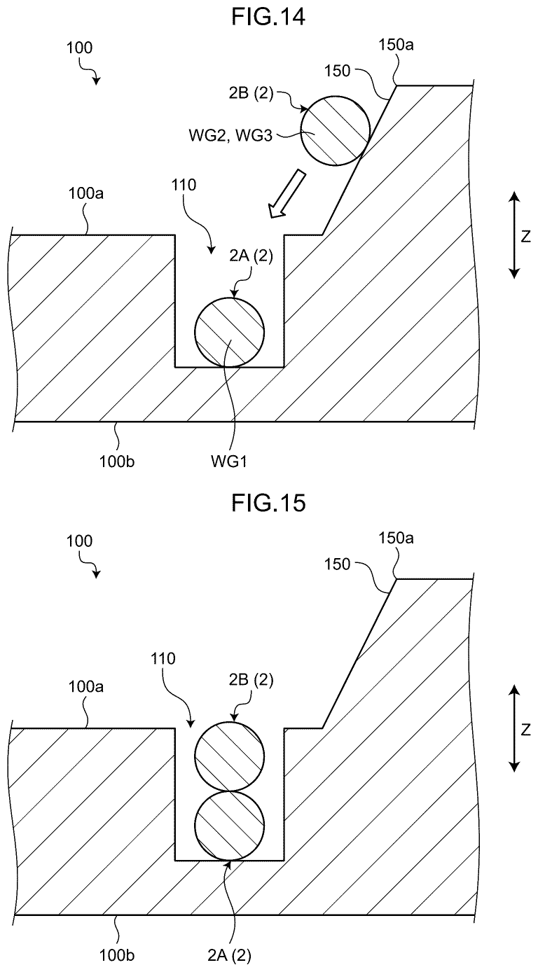

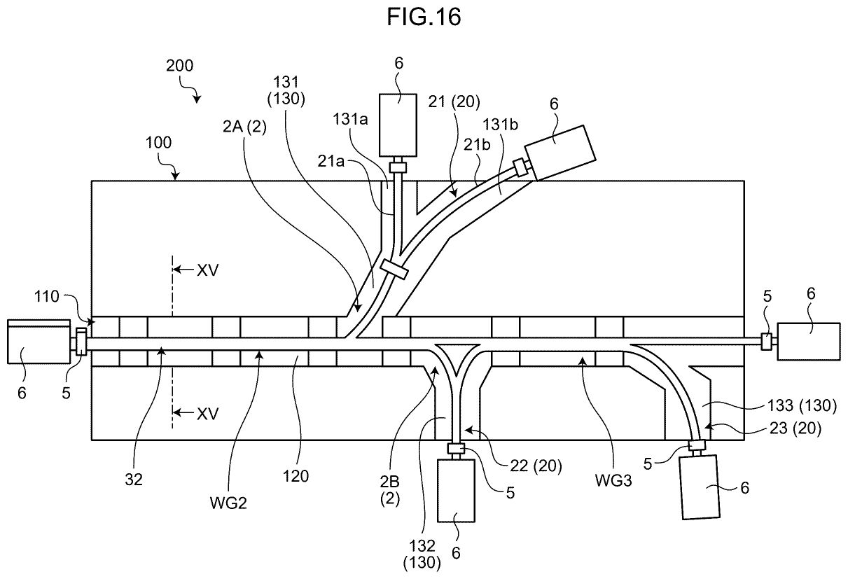

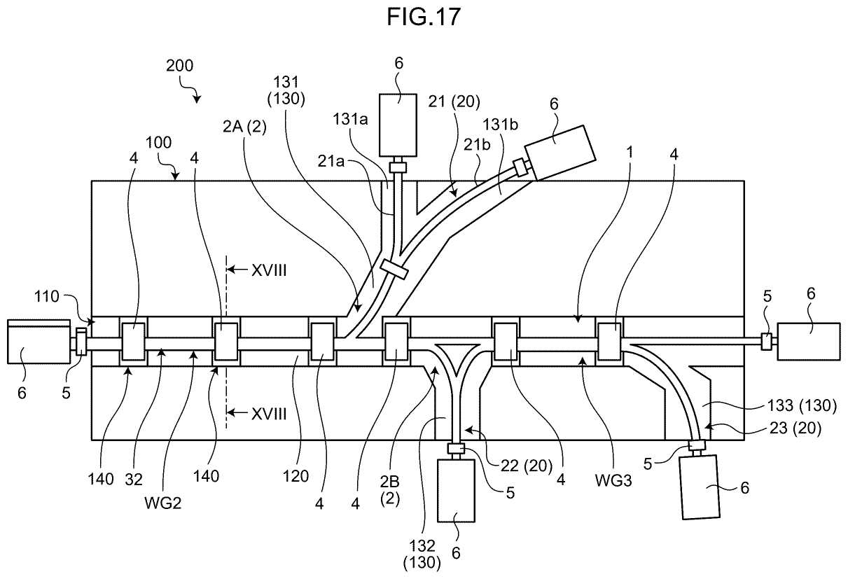

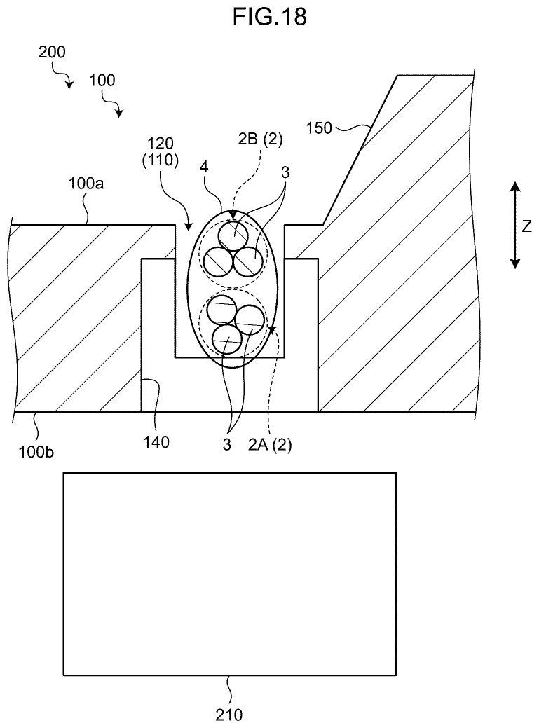

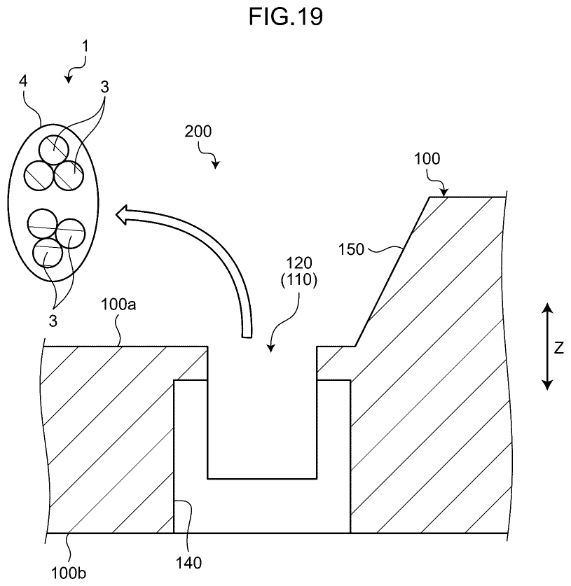

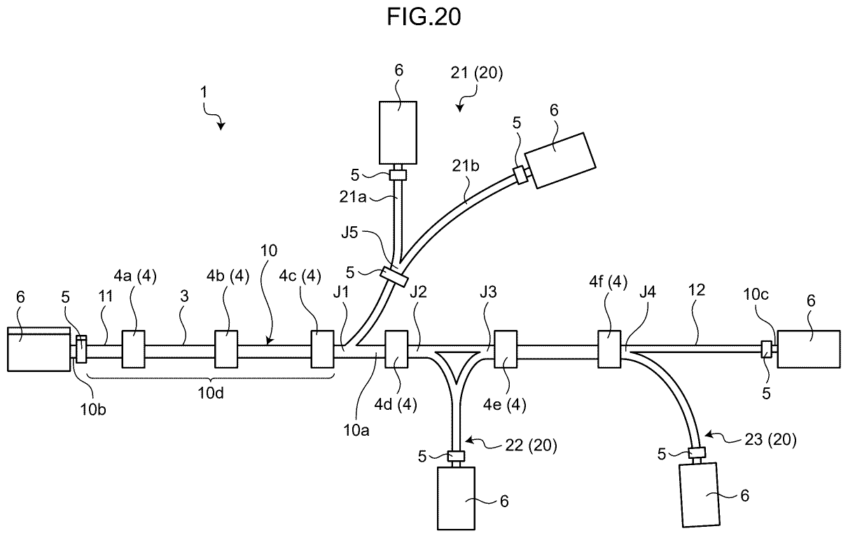

FIG. 11 is a cross-sectional view of the sub harness placed on an inclined surface. FIG. 12 is a cross-sectional view of the sub harness housed in a groove portion. FIG. 13 is a plan view of the sub harness housed in the groove portion. FIG. 14 is a cross-sectional view of the sub harnesses placed on the inclined surface. FIG. 15 is a cross-sectional view of the sub harnesses housed in the groove portion. FIG. 16 is a plan view of the sub harnesses housed in the groove portion. FIG. 17 is a plan view illustrating the first bundling members attached to a trunk wire portion. FIG. 18 is a cross-sectional view illustrating the first bundling member attached to the trunk wire portion. FIG. 19 is a cross-sectional view illustrating the wire harness taken out from the groove portion. FIG. 20 illustrates the arrangement of the first bundling members in the trunk wire portion.

FIGS. 2 and 5 illustrate a II-II cross section in FIG. 1. FIG. 8 illustrates an VIII-VIII cross section in FIG. 7. FIG. 9 illustrates a IX-IX cross section in FIG. 7. FIG. 18 illustrates an XVIII-XVIII cross section in FIG. 17.

As illustrated in FIG. 1, a wire harness 1 of the embodiment includes a trunk wire portion 10 and at least one branch wire portion 20. The trunk wire portion 10 is formed by bundling a plurality of electric wires. The trunk wire portion 10 is a main portion of the wire harness 1. The branch wire portion 20 branches off from the trunk wire portion 10. For example, the trunk wire portion 10 may include a portion obtained by bundling the largest number of electric wires in the wire harness 1, or may include a portion having the largest outer diameter in the wire harness 1.

The trunk wire portion 10 in front of a branch portion may include a relatively larger number of electric wires than the branch wire portion 20. In the branch portion, the branch wire portion 20 branches off from the trunk wire portion 10. For example, the wire harness 1 in FIG. 1 includes a branch portion J1. In the branch portion J1, a first branch wire portion 21 branches off from the trunk wire portion 10. In a portion 10a in front of the branch portion J1 in the trunk wire portion 10, the trunk wire portion 10 may include a larger number of electric wires than the first branch wire portion 21. In the portion 10a in front of the branch portion J1 in the trunk wire portion 10, the trunk wire portion 10 may have a larger outer diameter than the first branch wire portion 21. In other words, in front of the branch portion J1, a portion including a relatively large number of electric wires may be defined as the trunk wire portion 10, or a portion having a relatively large outer diameter may be defined as the trunk wire portion 10.

The trunk wire portion 10 includes a plurality of electric wires 3 and a plurality of first bundling members 4 that bundle the plurality of electric wires 3. As illustrated in FIG. 2, in the trunk wire portion 10, the first bundling member 4 bundles the plurality of electric wires 3. The electric wire 3 includes, for example, a core wire and a coating that coats the core wire. Note that, in the trunk wire portion 10, the first bundling member 4 may bundle any number of electric wires 3 having any diameter. For example, the plurality of electric wires 3 bundled by the first bundling member 4 may include electric wires having different diameters. The illustrated trunk wire portion 10 has an oval cross-sectional shape. Note, however, that the cross-sectional shape of the trunk wire portion 10 is not limited to an oval shape.

The first bundling member 4 bundles the plurality of electric wires 3. The first bundling member 4 may be, for example, a binding member such as a binding band, a tape member such as adhesive tape, or another member. The first bundling member 4 goes around the plurality of electric wires 3 at the same position in the extending direction of the electric wires 3.

FIG. 3 illustrates a binding band 40, which is an example of the first bundling member 4. The binding band 40 in FIG. 3 includes a head portion 41 and a band portion 42. The head portion 41 includes a hole portion and a locking portion. The band portion 42 is inserted into the hole portion. The locking portion is disposed in the hole portion. The band portion 42 goes around the plurality of electric wires 3 at the same position in an extending direction X of the electric wires 3. In other words, the band portion 42 is wound around the plurality of electric wires 3 without changing the position in the extending direction X. Therefore, the band portion 42 is wound around the plurality of electric wires 3 so as to form a single circumference surrounding the plurality of electric wires 3.

The band portion 42 is inserted into the hole portion of the head portion 41, and is locked by the locking portion. Note that the first bundling member 4 may be a band clip including a clip portion to be inserted into a hole portion provided in a wall portion of a fixation target. As illustrated in FIG. 1, the plurality of first bundling members 4 is disposed separately from each other in the extending direction X. In other words, the plurality of electric wires 3 is exposed in a section between one first bundling member 4 and another first bundling member 4.

FIG. 4 illustrates tape members 43, which are examples of the first bundling members 4. The tape member 43 is an adhesive tape having an adhesive surface, and is wound around the plurality of electric wires 3. The tape member 43 goes around the plurality of electric wires 3 at the same position in the extending direction X of the electric wires 3 to bundle the plurality of electric wires 3. That is, the tape member 43 is wound around the plurality of electric wires 3 such that a portion 43a located inside and a portion 43b overlapping on the outside are located at the same position in the extending direction X in a portion where the portion 43a and the portion 43b overlap each other. As illustrated in FIG. 4, the plurality of electric wires 3 is exposed in a section between one first bundling member 4 and another first bundling member 4.

FIG. 5 illustrates a sheet member 44, which is an example of the first bundling members 4. FIG. 5 illustrates a cross section at the same cross-sectional position as that in FIG. 2. The sheet member 44 is a weldable sheet, and is formed of, for example, insulating synthetic resin. The sheet member 44 is wound around and welded to the plurality of electric wires 3. The sheet member 44 goes around the plurality of electric wires 3 at the same position in the extending direction X of the electric wires 3 to bundle the plurality of electric wires 3. The sheet member 44 includes a first end 44a and a second end 44b. The first end 44a and the second end 44b overlap with and are welded to each other. A method of the welding may include heating through a heat source, high frequency welding, ultrasonic welding, and other welding methods. Furthermore, the welding form of the sheet member 44 is not limited to the form illustrated in FIG. 5.

As illustrated in FIG. 1, the trunk wire portion 10 includes a first end 11 and a second end 12. The first end 11 is one end in the extending direction of the trunk wire portion 10. The second end 12 is the other end in the extending direction of the trunk wire portion 10. That is, the trunk wire portion 10 of the embodiment includes the two ends 11 and 12.

As illustrated in FIG. 1, the branch wire portions 20 of the embodiment include the first branch wire portion 21, a second branch wire portion 22, and a third branch wire portion 23. The trunk wire portion 10 includes branch portions J1, J2, J3, and J4, which are branch portions from the branch wire portions 20. The branch portions J1, J2, J3, and J4 are arranged in this order from the first end 11 to the second end 12.

The first branch wire portion 21 branches off from the trunk wire portion 10 in the branch portion J1. The branch portion J1 is the closest to the first end 11 of the plurality of branch portions J1, J2, J3, and J4. The third branch wire portion 23 branches off from the trunk wire portion 10 in the branch portion J4. The branch portion J4 is the farthest from the first end 11 of the plurality of branch portions J1, J2, J3, and J4. The second branch wire portion 22 branches off from the trunk wire portion 10 in the branch portions J2 and J3. That is, the second branch wire portion 22 branches off from the trunk wire portion 10 at a position between the branch portions J1 and J4.

The first branch wire portion 21 is divided into two branch wire portions 21a and 21b on the distal end side. Each of the branch wire portions 21a and 21b may include the plurality of electric wires 3. A second bundling member 5 is attached to a branch portion J5 of the branch wire portions 21a and 21b. The second bundling member 5 is, for example, a binding band or tape. The second bundling member 5 may go around the plurality of electric wires 3 to be attached at the same position in the extending direction of the electric wires 3.

Components 6 are connected to tip ends of the branch wire portions 21a and 21b. The components 6 are, for example, connectors. Note that the components 6 are not limited to connectors. The components 6 may be electric connection boxes or terminal blocks, or may be other components. The components 6 may be terminals or bus bars connected to the electric wires 3. Second bundling members 5 bundle the electric wires 3 of the tip ends in the branch wire portions 21a and 21b. The second bundling members 5 are attached to the vicinities of the components 6.

The second branch wire portion 22 includes the electric wire 3 that branches off from the trunk wire portion 10 in the branch portion J2 and the electric wire 3 that branches off from the trunk wire portion 10 in the branch portion J3. The component 6 is connected to the tip end of the second branch wire portion 22. Although the component 6 is, for example, a connector, the component 6 is not limited thereto. The second bundling member 5 bundles the electric wires 3 of the tip end in the second branch wire portion 22. The second bundling member 5 is attached to the vicinities of the component 6.

The component 6 is connected to the tip end of the third branch wire portion 23. Although the component 6 is, for example, a connector, the component 6 is not limited thereto. The second bundling member 5 bundles the electric wires 3 of the tip end in the third branch wire portion 23. The second bundling member 5 is attached to the vicinities of the component 6.

The component 6 is connected to a tip end on the side of the first end 11 in the trunk wire portion 10. Although the component 6 is, for example, a connector, the component 6 is not limited thereto. The second bundling member 5 bundles the plurality of electric wires 3 at a tip end 10b on the side of the first end 11. The second bundling member 5 is attached to the vicinities of the component 6.

The component 6 is connected to a tip end on the side of the second end 12 in the trunk wire portion 10. Although the component 6 is, for example, a connector, the component 6 is not limited thereto. The second bundling member 5 bundles the plurality of electric wires 3 at a tip end 10c on the side of the second end 12. The second bundling member 5 is attached to the vicinities of the component 6.

As described below, the illustrated wire harness 1 includes a plurality of sub harnesses 2. As illustrated in FIG. 6, the wire harness 1 of the embodiment includes a first sub harness 2A and a second sub harness 2B. For example, a sub-harness manufacturing device manufactures the sub harnesses 2A and 2B.

The sub-harness manufacturing device includes, for example, a cutting device, a crimping device, a charging device, and a binding device. The cutting device cuts the electric wire 3. The crimping device crimps a terminal to an end of the electric wire 3 to manufacture an electric-wire-fitted terminal. The charging device inserts the electric-wire-fitted terminal into a connector. The binding device attaches a bundling member to the plurality of electric wires 3, and dimensions a branch wire portion. That is, the binding device has a function of forming a branch for the plurality of electric wires 3. The binding device may further have a function of attaching an exterior member to the plurality of electric wires 3.

As illustrated in FIG. 6, the first sub harness 2A includes a first electric wire group WG1 including the plurality of electric wires 3. The first sub harness 2A includes a sub trunk wire portion 31 and the first branch wire portion 21. The sub trunk wire portion 31 is a part of the trunk wire portion 10, and includes the plurality of electric wires 3. The components 6 are connected to both ends of the sub trunk wire portion 31. The second bundling members 5 bundle tip ends 31b and 31c of the sub trunk wire portion 31. The tip ends 31b and 31c correspond to the tip ends 10b and 10c of the trunk wire portion 10.

The first electric wire group WG1 includes a branch portion J11. The branch portion J11 corresponds to the branch portion J1 of the wire harness 1. That is, the first branch wire portion 21 is preliminarily dimensioned in a process of manufacturing the first sub harness 2A. A bundling member such as a binding band and a tape member may be attached to the branch portion J11.

The first sub harness 2A is manufactured in a process of manufacturing a sub harness. For example, the above-described sub-harness manufacturing device executes the process of manufacturing a sub harness. The process of manufacturing a sub harness includes a process of manufacturing the first electric wire group WG1. The sub-harness manufacturing device cuts a plurality of electric wires to a predetermined length to manufacture the first electric wire group WG1.

A process of manufacturing the first sub harness 2A can include a process of manufacturing an electric-wire-fitted terminal. In this process, the sub-harness manufacturing device crimps a terminal to the electric wires 3 of the first electric wire group WG1 to manufacture multiple-electric-wire-fitted terminals.

The process of manufacturing the first sub harness 2A can include a process of inserting terminals into connectors. In this process, the sub-harness manufacturing device inserts the multiple-electric-wire-fitted terminals into connectors.

The process of manufacturing the first sub harness 2A includes a process of binding the plurality of electric wires 3. The sub-harness manufacturing device dimensions a branch wire portion, and bundles the plurality of electric wires 3 with the second bundling member 5. In the binding process, the second bundling members 5 are attached to the sub trunk wire portion 31. Furthermore, in the binding process, the second bundling members 5 are attached to a branch portion J15 of the first branch wire portion 21 and tip ends of the branch wire portions 21a and 21b. The binding process may include a process of bending the electric wires 3 of the first branch wire portion 21 in the branch portions J11 and J15.

The second sub harness 2B includes a second electric wire group WG2 including the plurality of electric wires 3 and a third electric wire group WG3 including the plurality of electric wires 3. The second sub harness 2B includes a sub trunk wire portion 32, the second branch wire portion 22, and the third branch wire portion 23. The sub trunk wire portion 32 is a part of the trunk wire portion 10, and includes the plurality of electric wires 3. The sub trunk wire portion 32 of the embodiment includes a part of the second electric wire group WG2 and a part of the third electric wire group WG3. More specifically, the sub trunk wire portion 32 includes a section 32a and a section 32b. The section 32a is a part of the second electric wire group WG2. The section 32b is a part of the third electric wire group WG3.

The second branch wire portion 22 includes an end 22a of the second electric wire group WG2 and an end 22b of the third electric wire group WG3. The second bundling member 5 bundles tip ends of the ends 22a and 22b. The component 6 of the second branch wire portion 22 is connected to the electric wire 3 of the end 22a and the electric wire 3 of the end 22b. The second electric wire group WG2 includes a bent portion J22. In the bent portion J22, the second branch wire portion 22 branches off from the section 32a constituting the sub trunk wire portion 32. The bent portion J22 corresponds to the branch portion J2 of the wire harness 1.

The third electric wire group WG3 includes bent portions J33 and J34. In the bent portion J33, the second branch wire portion 22 branches off from the section 32b constituting the sub trunk wire portion 32. The bent portion J33 corresponds to the branch portion J3 of the wire harness 1. In the bent portion J34, the third branch wire portion 23 branches off from the section 32b constituting the sub trunk wire portion 32. The bent portion J34 corresponds to the branch portion J4 of the wire harness 1.

The third branch wire portion 23 is an end on the side opposite to the side of the end 22b in the third electric wire group WG3. The component 6 is connected to the distal end of the third branch wire portion 23. Furthermore, the second bundling member 5 bundles the tip end of the third branch wire portion 23.

The second bundling member 5 bundles a tip end 32c of the sub trunk wire portion 32. The tip end 32c corresponds to the tip end 10b of the trunk wire portion 10. The component 6 is connected to the tip end 32c.

The second sub harness 2B is manufactured in a process of manufacturing a sub harness. The process of manufacturing the second sub harness 2B includes a process of manufacturing the electric wire groups WG2 and WG3. The sub-harness manufacturing device cuts a plurality of electric wires to a predetermined length to manufacture the second electric wire group WG2 and the third electric wire group WG3.

The process of manufacturing the second sub harness 2B can include a process of manufacturing an electric-wire-fitted terminal. The sub-harness manufacturing device crimps terminals to the electric wires 3 of the electric wire groups WG2 and WG3 to manufacture multiple-electric-wire-fitted terminals.

The process of manufacturing the second sub harness 2B can include a process of inserting terminals into connectors. The sub-harness manufacturing device inserts the electric-wire-fitted terminals of the electric wire groups WG2 and WG3 into connectors.

The process of manufacturing the second sub harness 2B includes a process of binding the plurality of electric wires 3. The sub-harness manufacturing device dimensions a branch wire portion, and bundles the plurality of electric wires 3 with the second bundling member 5. In the binding process, the second bundling members 5 are attached to the sub trunk wire portion 32. Furthermore, the second bundling members 5 are attached to the tip end of the second branch wire portion 22 and the tip end of the third branch wire portion 23. Furthermore, in the binding process, the bent portion J22 is formed in the second electric wire group WG2, and the bent portions J33 and J34 are formed in the third electric wire group WG3.

FIG. 7 illustrates a jig plate 100 to be used to manufacture the wire harness 1. The jig plate 100 is a plate-shaped work table. The jig plate 100 is formed of, for example, wood, resin material, metal material, and so on. The jig plate 100 has, for example, a rectangular shape in plan view. Note, however, that the jig plate 100 may have any shape, which is determined in accordance with the shape of the wire harness 1. The jig plate 100 may have an L shape and a U shape, or another shape in plan view.

The jig plate 100 includes a groove portion 110 that houses the plurality of electric wires 3. The groove portion 110 includes a main groove 120 and sub grooves 130 that branch off from the main groove 120. The main groove 120 houses the trunk wire portion 10 of the wire harness 1. The sub grooves 130 house the branch wire portions 20 of the wire harness 1.

The illustrated main groove 120 linearly extends along the longitudinal direction of the jig plate 100. The main groove 120 extends from one end to the other end of the jig plate 100, and is opened toward lateral sides of the jig plate 100.

The sub grooves 130 branch off from the main groove 120 in directions intersecting with the extending direction of the main groove 120. The sub grooves 130 extend toward ends of the jig plate 100, and are opened toward lateral sides of the jig plate 100. That is, the sub grooves 130 extend from the main groove 120 to the ends of the jig plate 100.

The illustrated jig plate 100 includes, as the sub grooves 130, a first sub groove 131, a second sub groove 132, and a third sub groove 133. The first sub groove 131 houses the first branch wire portion 21. The first sub groove 131 is divided into two sub grooves 131a and 131b on the distal end side. The sub groove 131a houses the branch wire portion 21a. The sub groove 131b houses the branch wire portion 21b.

The second sub groove 132 houses the second branch wire portion 22. The third sub groove 133 houses the third branch wire portion 23. The second sub groove 132 and the third sub groove 133 branch off from the main groove 120 toward the side opposite to the side of the first sub groove 131.

As illustrated in FIG. 8, the jig plate 100 has a first surface 100a and a second surface 100b. The first surface 100a and the second surface 100b face opposite directions. The jig plate 100 of the embodiment is installed with the first surface 100a facing upward and the second surface 100b facing downward, for example. The jig plate 100 may be installed so as to be inclined to a floor surface. The jig plate 100 is supported from below by legs or a frame, for example.

The groove portion 110 is opened to the first surface 100a, and is recessed from the first surface 100a toward the second surface 100b. The groove portion 110 has, for example, a rectangular cross-sectional shape. The jig plate 100 has an inclined surface 150 that guides the sub harnesses 2 to the groove portion 110. The inclined surface 150 is inclined with respect to a depth direction Z of the groove portion 110. The inclined surface 150 includes an upper end 150a and a lower end 150b. The lower end 150b of the inclined surface 150 is disposed in the vicinity of a shoulder 110a of the groove portion 110. The inclined surface 150 is inclined with respect to a depth direction Z so as to approach the groove portion 110 from the upper end 150a toward the lower end 150b.

As illustrated in FIG. 7, the groove portion 110 has a plurality of through holes 140. In the jig plate 100 of the embodiment, the through holes 140 are provided in the main groove 120. The plurality of through holes 140 is arranged at intervals along the extending direction of the main groove 120. As illustrated in FIG. 9, the through hole 140 penetrates the jig plate 100 along the depth direction Z of the groove portion 110. That is, the through hole 140 penetrates from a bottom surface 110b of the groove portion 110 to the second surface 100b. The through hole 140 may have a width Wd1 larger than the width of the groove portion 110.

A wire harness manufacturing system 200 including the jig plate 100 includes attachment devices 210. The attachment devices 210 attach the first bundling members 4 to the plurality of electric wires 3. The attachment devices 210 are arranged adjacent to the through holes 140. The attachment devices 210 are arranged below the through holes 140, for example. In the wire harness manufacturing system 200 of the embodiment, the attachment devices 210 are arranged for the plurality of through holes 140. That is, a process of attaching the plurality of first bundling members 4 to the electric wires 3 can be executed in parallel.

Here, a method of manufacturing a wire harness by using the jig plate 100 will be described. The method of manufacturing a wire harness according to the embodiment includes a housing process, a bundling process, and a carrying process.

In the housing process, the preliminarily manufactured sub harnesses 2 are housed in the groove portion 110 of the jig plate 100. A worker may perform the housing process. A conveyance device 220 may perform the housing process. In the housing process, all sub harnesses 2 constituting the wire harness 1 are housed in the groove portion 110. For example, when the wire harness 1 includes the first sub harness 2A and the second sub harness 2B, the first sub harness 2A and the second sub harness 2B are housed in the groove portion 110 in the order.

FIG. 10 illustrates the first sub harness 2A conveyed by the conveyance device 220. The conveyance device 220 takes out the first sub harness 2A placed at a predetermined part, and houses the first sub harness 2A in the groove portion 110 of the jig plate 100. The conveyance device 220 may be a robot arm. In FIG. 10, circles indicate examples of holding parts Hd held by the conveyance device 220. The holding parts Hd are, for example, the tip ends 31b and 31c of the sub trunk wire portion 31 and the tip end of the first branch wire portion 21. A holding part Hd may be set in the branch portion J11.

The conveyance device 220 includes, for example, a hook or the like that holds a holding part Hd. In this case, the conveyance device 220 hangs the first sub harness 2A with a hook or the like, and conveys the first sub harness 2A.

FIG. 11 illustrates the first sub harness 2A placed on the inclined surface 150 of the jig plate 100. The conveyance device 220 places the first sub harness 2A on the inclined surface 150. The first electric wire group WG1 placed on the inclined surface 150 slides down along the inclined surface 150, and enters the groove portion 110. That is, the first electric wire group WG1 of the first sub harness 2A is guided to the groove portion 110 by the inclined surface 150.

Note that a mechanism that sends the first electric wire group WG1 to the groove portion 110 may be provided in the jig plate 100. For example, a movable arm that sends the first electric wire group WG1 to the groove portion 110 may be provided in the jig plate 100. Even if the first electric wire group WG1 stops at the shoulder 110a of the groove portion 110 or an entrance of the groove portion 110, the arm or the like sends the first electric wire group WG1 farther to the groove portion 110.

FIGS. 12 and 13 illustrate the first sub harness 2A housed in the groove portion 110. The first electric wire group WG1 is housed in the groove portion 110, and extends along the groove portion 110. As illustrated in FIG. 13, the sub trunk wire portion 31 of the first sub harness 2A is housed in the main groove 120, and extends along the main groove 120. The sub trunk wire portion 31 is housed in the main groove 120 so as to cause the components 6 and the second bundling members 5 at both ends to protrude from the main groove 120.

The first branch wire portion 21 is housed in the first sub groove 131, and extends along the first sub groove 131. The branch wire portions 21a and 21b are housed in sub grooves 131a and 131b, respectively. The first branch wire portion 21 is housed in the first sub groove 131 so as to cause the components 6 of the branch wire portions 21a and 21b and the second bundling members 5 of the tip end to protrude from the sub grooves 131a and 131b. The first branch wire portion 21 is housed in the first sub groove 131, which causes the sub trunk wire portion 31 to be positioned with respect to the main groove 120.

The wire harness manufacturing system 200 preferably checks the housing state of the first sub harness 2A with respect to the groove portion 110. For example, the wire harness manufacturing system 200 can image the first sub harness 2A placed on the jig plate 100, and determine, by image recognition, whether the first sub harness 2A is correctly housed in the groove portion 110.

Moreover, the conveyance device 220 houses the second sub harness 2B in the groove portion 110. The conveyance device 220 takes out the second sub harness 2B placed at a predetermined part, and houses the second sub harness 2B in the groove portion 110 of the jig plate 100.

FIG. 14 illustrates the second sub harness 2B placed on the inclined surface 150 of the jig plate 100. The conveyance device 220 places the second sub harness 2B on the inclined surface 150. The second electric wire group WG2 and the third electric wire group WG3 placed on the inclined surface 150 slide down along the inclined surface 150, and enter the groove portion 110. That is, the electric wire groups WG2 and WG3 of the second sub harness 2B are guided to the groove portion 110 by the inclined surface 150. A mechanism such as an arm may send the electric wire groups WG2 and WG3 to the groove portion 110.

FIGS. 15 and 16 illustrate the second sub harness 2B housed in the groove portion 110. As illustrated in FIG. 16, the electric wire groups WG2 and WG3 are housed in the groove portion 110, and extend along the groove portion 110. More specifically, the sub trunk wire portion 32 is housed in the main groove 120, and extends along the main groove 120. The sub trunk wire portion 32 is housed in the main groove 120 so as to cause the component 6 and the second bundling member 5 connected to the tip end to protrude from the main groove 120.

The second branch wire portion 22 is housed in the second sub groove 132, and extends along the second sub groove 132. The second branch wire portion 22 is housed in the second sub groove 132 so as to cause the component 6 and the second bundling member 5 connected to the tip end to protrude from the second sub groove 132. The third branch wire portion 23 is housed in the third sub groove 133, and extends along the third sub groove 133. The third branch wire portion 23 is housed in the third sub groove 133 so as to cause the component 6 and the second bundling member 5 connected to the tip end to protrude from the third sub groove 133. The second branch wire portion 22 is housed in the second sub groove 132, and the third branch wire portion 23 is housed in the third sub groove 133, which causes the sub trunk wire portion 32 to be positioned with respect to the main groove 120.

The wire harness manufacturing system 200 preferably checks the housing state of the second sub harness 2B with respect to the groove portion 110. For example, the wire harness manufacturing system 200 can image the second sub harness 2B placed on the jig plate 100, and determine, by image recognition, whether the second sub harness 2B is correctly housed in the groove portion 110.

As illustrated in FIG. 15, the second sub harness 2B overlaps the first sub harness 2A inside the groove portion 110. The jig plate 100 may include a mechanism of pressing the second sub harness 2B to the first sub harness 2A in order to inhibit floating of the second sub harness 2B. The pressing mechanism may be, for example, a movable arm.

When all the sub harnesses 2A and 2B are housed in the groove portion 110, the attachment devices 210 of the wire harness manufacturing system 200 attach the first bundling members 4 to the plurality of electric wires 3. FIG. 17 illustrates the wire harness 1 to which the plurality of first bundling members 4 is attached. The first bundling members 4 are attached at portions facing the through holes 140 in the sub trunk wire portions 31 and 32. The first bundling members 4 bundle the plurality of electric wires 3 in each of the plurality of through holes 140.

As illustrated in FIG. 18, the first bundling member 4 is attached to the plurality of electric wires 3 inside the main groove 120. The first bundling member 4 puts the electric wires 3 of the first sub harness 2A and the electric wires 3 of the second sub harness 2B together to bundle the plurality of electric wires 3. The attachment devices 210 of the embodiment attach the first bundling members 4 to the electric wires 3 in parallel or simultaneously in each of the plurality of through holes 140.

When all the first bundling members 4 are attached, the wire harness 1 is taken out from the groove portion 110 as illustrated in FIG. 19. The conveyance device 220 may take out the wire harness 1. A device different from the conveyance device 220 may take out the wire harness 1 from the groove portion 110. A worker may take out the wire harness 1 from the groove portion 110.

The wire harness 1 may be taken out from the groove portion 110 by lowering the jig plate 100. In this case, the wire harness manufacturing system 200 preferably includes a support member such as a column that supports the wire harness 1. The wire harness manufacturing system 200 preferably includes a mechanism that raises and lowers the jig plate 100 with respect to the support member. The wire harness 1 supported by the support member is taken out from the groove portion 110 by lowering the jig plate 100 with respect to the support member.

FIG. 20 illustrates the wire harness 1 taken out from the jig plate 100. The plurality of first bundling members 4 attached to the trunk wire portion 10 includes members 4a, 4b, 4c, 4d, 4e, and 4f. The members 4a, 4b, and 4c are arranged at equal intervals along the extending direction of the trunk wire portion 10. The member 4c is attached to the branch portion J1. The member 4c positions the branch portion J1 of the trunk wire portion 10 and the first branch wire portion 21, and determines the wire length of the first branch wire portion 21.

The member 4d is attached to the branch portion J2. The member 4e is attached to the branch portion J3. The members 4d and 4e position the branch portions J2 and J3 of the trunk wire portion 10 and the second branch wire portion 22, and determine the wire length of the second branch wire portion 22.

The member 4f is attached to the branch portion J4. The member 4f positions the branch portion J4 of the trunk wire portion 10 and the third branch wire portion 23, and determines the wire length of the third branch wire portion 23. As illustrated above, in the wire harness 1 of the embodiment, the first bundling members 4 are attached to the branch portions J1, J2, J3, and J4 of the branch wire portions 21, 22, and 23 in the trunk wire portion 10. Furthermore, in a section 10d including no branch portion in the trunk wire portion 10, the first bundling members 4 are attached at equal intervals.

In the method of manufacturing a wire harness according to the embodiment, at least one preliminarily manufactured sub harness is set in the groove portion 110 of the jig plate 100, and a first bundling member 4 is attached to a sub trunk wire portion to form the trunk wire portion 10. The first bundling member 4 is attached to the sub trunk wire portion with the sub trunk wire portion being housed in the main groove 120, which inhibits occurrence of meandering and the like in the completed trunk wire portion 10. Furthermore, occurrence of variations in the wire length of the trunk wire portion 10 is inhibited. Furthermore, occurrence of variations in the wire length of the trunk wire portion 10 from one branch wire portion to another branch wire portion is inhibited. In other words, occurrence of variations in the positions of the branch portions J1, J2, J3, and J4 is inhibited.

Furthermore, in the method of manufacturing a wire harness according to the embodiment, the plurality of first bundling members 4 can be attached to the sub trunk wire portion in parallel. Thus, a manufacturing time required for manufacturing the trunk wire portion 10 can be shortened.

In the wire harness 1 of the embodiment, the electric wire 3 is exposed between one first bundling member 4 and another first bundling member 4. That is, the trunk wire portion 10 can be easily bent between the two first bundling members 4. Therefore, the trunk wire portion 10 can have a curved shape when the wire harness 1 is conveyed. For example, the wire harness 1 may be conveyed with the trunk wire portion 10 having a spiral shape. Thus, the volume of a container that houses the wire harness 1 is reduced.

Furthermore, the trunk wire portion 10 that is easily bent improves workability of routing work at the time when the wire harness 1 is routed to a vehicle and the like.

As described above, in the method of manufacturing a wire harness according to the embodiment, the plurality of electric wires 3 is housed in the groove portion 110 of the jig plate 100 including the groove portion 110 in a process of housing an electric wire, which includes a process of housing an electric wire and a process of forming a trunk wire portion. In the process of forming a trunk wire portion, the trunk wire portion 10 in which the plurality of electric wires 3 is bundled is formed by attaching the plurality of first bundling members 4 to the plurality of electric wires 3 housed in the groove portion 110.

In the process of forming a trunk wire portion, the first bundling members 4 are attached to the plurality of electric wires 3 in each of the plurality of through holes 140 formed at intervals in the groove portion 110. Furthermore, in the process of forming a trunk wire portion, one first bundling member 4 goes around the plurality of electric wires 3 at the same position in the extending direction X of the electric wires 3. In the method of manufacturing a wire harness according to the embodiment, the wire harness 1 including a flexible trunk wire portion 10 can be manufactured.

In the process of forming a trunk wire portion, for example, the plurality of first bundling members 4 is attached to the plurality of electric wires 3 in parallel. In the wire harness manufacturing system 200 of the embodiment, the plurality of first bundling members 4 can be attached to the plurality of electric wires 3 in parallel. The plurality of first bundling members 4 is attached in parallel, which improves efficiency of the process of forming a trunk wire portion.

The wire harness 1 of the embodiment includes the trunk wire portion 10 and branch wire portions 20. The trunk wire portion 10 is formed by bundling the plurality of electric wires 3. The branch wire portions 20 branch off from the trunk wire portion 10. The trunk wire portion 10 includes the plurality of electric wires 3 and the plurality of first bundling members 4 that bundle the plurality of electric wires 3. One first bundling member 4 goes around the plurality of electric wires 3 at the same position in the extending direction X of the electric wires 3 to bundle the plurality of electric wires 3. The first bundling member 4 is disposed separately from another first bundling member 4 in the extending direction X. In the wire harness 1 of the embodiment, in the trunk wire portion 10, the plurality of first bundling members 4 is arranged separately from another first bundling member 4. Thus, the wire harness 1 of the embodiment can improve flexibility of the trunk wire portion 10.

The wire harness 1 of the embodiment includes the first sub harness 2A and the second sub harness 2B. The first sub harness 2A includes the first electric wire group WG1 and the components 6 connected to the first electric wire group WG1. The second sub harness 2B includes the second electric wire group WG2 and the components 6 connected to the second electric wire group WG2. The trunk wire portion 10 is formed by bundling at least some electric wires 3 of the first electric wire group WG1 and at least some electric wires 3 of the second electric wire group WG2 with the plurality of first bundling members 4. The plurality of first bundling members 4 separated from each other bundles the electric wires 3 of the plurality of sub harnesses 2, which inhibits a decrease in flexibility of the trunk wire portion 10.

Note that, when the second sub harness 2B includes the third electric wire group WG3, the trunk wire portion 10 may be formed by bundling at least some electric wires 3 of the first electric wire group WG1 and at least some electric wires 3 of the third electric wire group WG3 with the plurality of first bundling members 4. That is, the trunk wire portion 10 is formed by bundling the electric wire group of the first sub harness 2A and the electric wire group of the second sub harness 2B with the plurality of first bundling members 4.

In the wire harness 1 of the embodiment, the second bundling member 5 bundles tip ends of the plurality of electric wires 3. For example, the second bundling members 5 bundle the tip ends 10b and 10c of the trunk wire portion 10. For example, the second bundling members 5 bundle the tip ends of the branch wire portions 21, 22, and 23. The second bundling member 5 bundles a tip end of the electric wires 3, which improves handling property of the wire harness 1.

In the wire harness 1 of the embodiment, in the trunk wire portion 10, the plurality of electric wires 3 is exposed between one first bundling member 4 and another first bundling member 4. Thus, flexibility of the trunk wire portion 10 can be improved.

Note that the wire harness 1 may be formed by one sub harness 2. In this case, a portion constituting the trunk wire portion 10 in the sub harness 2 is housed in the main groove 120 of the jig plate 100, and the plurality of first bundling members 4 is attached. The wire harness 1 may include three or more sub harnesses 2. In this case, sub trunk wire portions of the sub harnesses 2 are housed in the main groove 120, and are bundled by the plurality of first bundling members 4.

Note that, in the bundling process, the first bundling members 4 may be arranged in the groove portion 110 before the sub harnesses 2 are housed. For example, when the first bundling members 4 are sheet members 44, the sheet members 44 may be preliminarily arranged in the groove portion 110. In this case, the sub harnesses 2 are placed on the sheet members 44. Thereafter, the attachment devices 210 attach the sheet members 44 to the plurality of electric wires 3.

A guide member may be disposed in the jig plate 100. The guide member causes a first bundling member 4 to go around the plurality of electric wires 3. For example, when the first bundling member 4 is the binding band 40, a guide member, such as a rail, may be provided. The guide member guides the band portion 42 of the binding band 40 along the outer peripheries of the plurality of electric wires 3. The guide member may constitute a part of a mechanism that sends the electric wire groups WG1, WG2, and WG3 of the sub harnesses 2 to the groove portion 110.

A resin member such as a protector may be attached to the wire harness 1 placed on the jig plate 100. For example, the resin member may be integrally molded to the trunk wire portion 10 in the process of forming a trunk wire portion or after the process of forming a trunk wire portion. In this case, the resin member is molded to the trunk wire portion 10 with the trunk wire portion 10 being housed in the main groove 120. For example, a mold is set to the trunk wire portion 10 in a through hole 140, and resin is poured into the mold to form the resin member.

The contents disclosed in the above-described embodiment can be appropriately combined and executed.

In a method of manufacturing a wire harness according to the present embodiment, in a process of forming a trunk wire portion, first bundling members are attached to a plurality of electric wires in a plurality of through holes formed at intervals in a groove portion, and one first bundling member goes around the plurality of electric wires at the same position in the extending direction of the electric wires. In a wire harness according to the present embodiment, the trunk wire portion includes the plurality of electric wires and the plurality of first bundling members that bundle the plurality of electric wires. One first bundling member goes around the plurality of electric wires at the same position in the extending direction of the electric wires, bundles the plurality of electric wires, and is arranged separately from another first bundling member in the extending direction. The method of manufacturing a wire harness and the wire harness according to the present embodiment can exhibit an effect of improving flexibility of the trunk wire portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a wire harness, comprising:
a process of housing a plurality of electric wires in a groove portion of a jig plate including the groove portion; and
a process of forming a trunk wire portion in which the plurality of electric wires is bundled, by attaching a plurality of first bundling members to the plurality of electric wires housed in the groove portion,
wherein, in the process of forming the trunk wire portion,
the first bundling members are attached to the plurality of electric wires in each of a plurality of through holes formed at an interval in the groove portion, and
one of the first bundling members goes around the plurality of electric wires at a same position in an extending direction of the electric wires.

2. The method of manufacturing a wire harness, according to claim 1,
wherein, in the process of forming the trunk wire portion, the plurality of first bundling members is attached to the plurality of electric wires in parallel.

3. A wire harness comprising:
a trunk wire portion formed by bundling a plurality of electric wires; and a branch wire portion that branches off from the trunk wire portion,
wherein the trunk wire portion includes: the plurality of electric wires; and a plurality of first bundling members that bundle the plurality of electric wires, and
one of the first bundling members goes around the plurality of electric wires at a same position in an extending direction of the electric wires, bundles the plurality of electric wires, and is arranged separately from another of the first bundling members in the extending direction.

4. The wire harness according to claim 3, further comprising:
a first sub harness including: a first electric wire group and a component connected to the first electric wire group; and
a second sub harness including: a second electric wire group; and a component connected to the second electric wire group,
wherein the trunk wire portion is formed by bundling at least some electric wires of the first electric wire group and at least some electric wires of the second electric wire group with the plurality of first bundling members.

5. The wire harness according to claim 3,
wherein a second bundling member bundles tip ends of the plurality of electric wires.

6. The wire harness according to claim 3,
wherein, in the trunk wire portion, the plurality of electric wires is exposed between one of the first bundling members and another of the first bundling members.
